(19) United States
(12) Patent Application Publication
(10) Pub. No.: US 2007/0269038 A1
(43) Pub. Date: Nov. 22, 2007

(54) DYNAMIC ROUTING OF CUSTOMER TELEPHONE CONTACTS IN REAL TIME

(75) Inventors: Shlomo Gonen, Calabasas, CA (US); Jonathan A. Gonen, Calabasas, CA (US); Danny Rosen, Valley Village, CA (US)

Correspondence Address: KELLY LOWRY & KELLEY, LLP, 6320 CANOGA AVENUE, SUITE 1650, WOODLAND HILLS, CA, 91367, US

(73) Assignee: METRO ENTERPRISES, INC., Beverly Hills, CA (US)

(21) Appl. No.: 11/777,876

(22) Filed: Jul. 13, 2007

Related U.S. Application Data
(63) Continuation-in-part of application No. 11/457,426, filed on Jul. 13, 2006.
Application No. 11/457,426 is a continuation-in-part of application No. 11/162,592, filed on Sep. 15, 2005.
Application No. 11/162,592 is a continuation-in-part of application No. 11/020,375, filed on Dec. 22, 2004, now Pat. No. 7,076,037.

(51) Int. Cl. H04M 3/00

(52) U.S. Cl. 379/265.02

(57) ABSTRACT

A process for dynamic routing of customer contacts to call recipients includes establishing accounts in a call recipient contact system for a plurality of call recipients. The plurality of call recipients are permitted to bid against one another for providing goods and/or services to a customer. A contact list is created and call recipients are ranked from a lowest bidding call recipient to a highest bidding call recipient. The contact is received from a customer and routed to the lowest bidding call recipient on the contact list. The call recipient account receiving the contact and fulfilling the transaction is credited an amount bid by the call recipient.

### BACKGROUND OF THE INVENTION

The present invention generally relates to routing customer contacts, such as by telephone call routing. More particularly, the present invention relates to a process for dynamically routing customer contacts to call recipients that bid for the opportunity to receive such contacts.

Consumers interested in acquiring services must first find a service provider capable of providing the required services. Typically, this means perusing a telephone directory and selecting a provider from an often long list of service providers. In some areas of the country, this requires that the consumer determine which service providers are sufficiently close to the consumer. Geographic location is important for services that must be completed in a reasonable time frame and for a reasonable cost. This process is frustrating and time consuming, particularly if the consumer must leave messages for unavailable service providers. After leaving a message, the consumer must wait for a return phone call from the service provider. Hopefully, the service provider returns the phone call shortly. In the meantime, the consumer may leave multiple messages with multiple service providers until reaching an available service provider. The consumer then deals with return phone calls of service providers whose services are no longer necessary.

Many consumers now own computers and have internet access. Searches are now conducted on the internet to find service providers. Some service providers have websites that provide information valuable to the consumer. Traditionally, service providers and other businesses on the internet pay for a “hit.” An advertiser incurs a “hit” each time an online user clicks or otherwise selects a link to arrive at the service provider website. Reaching a service provider this way requires two steps: (1) identifying a service provider on a website; and (2) generating a phone call or e-mail request. Moreover, such “hits” are not overly promising as the online user may surf the web by selecting and viewing several websites before calling a business or service provider. But, such advertising typically only costs the website owner a few cents even though acquiring business from a “hit” may be unlikely.

There are many consumer disadvantages when shopping for service providers online. First, accurate internet searches must be conducted to arrive at the service provider in question. Next, the online customer must determine which service providers are in close geographic proximity and are capable of providing the requisite services. This search requires that the customer own a computer and have the necessary internet connection. Moreover, it is estimated that approximately seventy percent (70%) of small to medium size businesses do not have active websites. Thus, there are millions of service providers that are unable to conduct transactions online. Such service providers may include restaurants, plumbers, and other small businesses. Most of these businesses do not even have an online presence.

Ingenio, Inc. developed an online pay-per-call system for routing telephone calls made by consumers to advertisers, as disclosed in U.S. Pat. No. 6,704,403. Ingenio publishes the name and telephone number (usually a unique toll free number) for registered advertisers, such as a service provider. When an online consumer searches for a particular service, Ingenio presents a list of service providers/advertisers to the consumer. The consumer selects a service provider from this list and dials the corresponding telephone number. If the service provider is not available, the consumer leaves a message with the service provider. A predetermined flat fee is charged for each call made to the service provider. The '403 patent discloses that this fee is paid by the potential customer. A portion of the fee paid by the potential customer is collected by Ingenio and the remainder of the fee is paid to the service provider. Accordingly, the service provider is compensated for taking the time to receive the consumer call. The '403 patent further discloses that a permanent fee is also chargeable to either the service provider or the potential customer after an initial time period, such as 10 minutes. The theory behind the flat fee is that if a potential customer is on the phone with a service provider for a significant duration, the likelihood that the service provider actually sells goods or performs services for the customer increases. Thus, the service provider does not need to pay for dead end “hits” or maintain a website or other internet presence.

The Ingenio system does have several drawbacks. First, the consumer must have a computer and internet access. Next, the consumer must conduct an accurate online search to find the list of service providers capable of providing the requisite service. Such a search may not take into account the geographic location of the consumer. The consumer then selects a single service provider, and if that service provider is not available, the consumer must leave a message. Even though the '403 patent discloses technology to facilitate the return of the consumer telephone call, the consumer is still left with the inevitable option of waiting for the service provider to return the call. Thereafter the consumer must wait for a return phone call or call another service provider on the list. The Ingenio system benefits various service providers who otherwise do not have an internet presence. But, the Ingenio system does little to benefit the consumer. Moreover, the '403 patent does not track other customer originated contacts, such as satellite enabled voice links, voiceover internet protocol (VoIP) contacts, or electronic messages.

Accordingly, there is a continuing need for a dynamic contact routing system that charges service providers only for contacts received. Such a call routing system should meet the needs of the customer and overcome the aforementioned drawbacks. The present invention fills these needs and provides other related advantages.

### SUMMARY OF THE INVENTION

The present invention resides in a process for dynamically routing customer originated contacts to call recipients. The process of the present invention presents the potential customer with a live conversation and immediate feedback, instead of the customer leaving a message and waiting for a call recipient to return the telephone call or contact.

The process of the present invention generally comprises the dynamic routing of customer contacts to call recipients that have established accounts in a call recipient contact system. A maximum acceptable bid for the call recipient is established. A plurality of call recipients are permitted to bid against one another for providing goods and/or services to a customer. A contact list comprising call recipients ranked from a lowest bidding call recipient to a highest bidding call recipient is provided. In a particularly preferred embodiment, bidding between call recipients is ongoing. Accordingly, call recipients may enter new bids for the per-contact charge. Call recipients are notified whenever bid ranking on the contact list changes. Contact lists are typically created according to call recipient type or geographic location. But, the present invention enables call recipients to select one or more contact lists based on other criteria. This is particularly preferred for call recipients that offer a plurality of services or have offices located in a plurality of geographic locations.

A contact from a customer is received and routed to the lowest bidding call recipient on the contact list. A call recipient to whom the customer contact is routed is permitted to accept or reject the contact by speech recognition or keypad entry. If the lowest bidding call recipient does not accept the contact, the customer contact is re-routed to the next lowest bidding call recipient on the contact list. The present invention also permits call recipients to set time periods of contact acceptance or rejection. The customer contact is routed to the next lowest bidding call recipient on the contact list if the lowest biding call recipient does not respond to the customer contact. The call recipient account receiving the contact is credited the amount bid by the call recipient.

The customer initiated contact may comprise a live conversation by a real-time communication link, such as a telephone link, a VoIP link, a satellite enabled voice link, or an audio/visual link. Alternatively, the contact may comprise a customer initiated electronic message. The electronic message may comprise a text message, an SMS or MMS message, an e-mail message, or the like. Selection of goods and/or services by the customer generates the contact.

When the customer initiated contact is a telephone call, the telephone number is preferably a toll free telephone number suggestive of a group of call recipients. Promoters may advertise the call recipient contact system, the telephone number, or any other contact information. Promoters may also obtain call recipient accounts. In this case, the system host or process owner share the fees charged to the customer with the promoter.

Typically, the geographic location of a customer is determined when a customer initiates the contact. Thereafter, a contact list based on that geographic location is selected. Selection is done automatically by deriving the geographic location from the customer's telephone contact information. Geographic location of the customer is also determinable from GPS assisted location, triangulation, operator assisted location, or cell phone assisted location. Alternatively, the customer is prompted to provide geographic location information. The system routes the customer to a contact list corresponding to the geographic location. Information is conveyed by the customer via speech recognition or telephone keypad entry, for example. In some instances, the customer is prompted to make a selection before being routed to a call recipient. This is performable by speech recognition or telephone keypad entry. In other instances, the customer is immediately routed to a call recipient to facilitate the appropriate routing of the customer contact.

The customer is billed, typically by the host or promoter, for the goods and/or services provided by the call recipient. Account status is available to the call recipient via e-mail, an online account, over the telephone, via customer support or mail. Crediting the call recipient account includes paying the call recipient in real-time or on a periodic basis. A call recipient may be removed from the call recipient contact list for failing to maintain its account.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flowchart depicting the steps taken generally, in accordance with the present invention, in routing a customer originated contact to a call recipient;

FIG. 2 is a flowchart depicting the steps for setting up a system embodying the present invention;

FIG. 3 is a flowchart depicting the steps for creating call recipient accounts and call recipient per-contact charge bidding, in accordance with the present invention;

FIG. 4 is a flowchart depicting the steps taken when a customer initiates a contact or a request for a call recipient, in accordance with the present invention;

FIG. 5 is a flowchart depicting the steps for setting up another system embodying the present invention;

FIG. 6 is a flowchart depicting the steps for creating call recipient accounts and call recipient bidding, in accordance with the present invention; and

FIG. 7 is a flowchart depicting the steps taken when a customer initiates a contact request for a call recipient, in accordance with the present invention.

### DETAILED DESCRIPTION OF THE PREFERRED EMBODIMENTS

As shown in the accompanying drawings, for purposes of illustration, the present invention resides in a dynamic contact routing process for linking customers, in need of goods or services, with a call recipient. As is more fully described herein, the present invention provides benefits to both potential customers and call recipients. A “customer” herein refers to any individual person, group, company or other related business, government agency or department, or any other entity known in the art that seeks goods, services, or information. A “call recipient” refers to any individual person, group, company or other related business, government agency or department, or any other entity known in the art that provides services, offers goods, or provides information. Call recipients belong to the system of the present invention by setting up an account, as is more fully described herein.

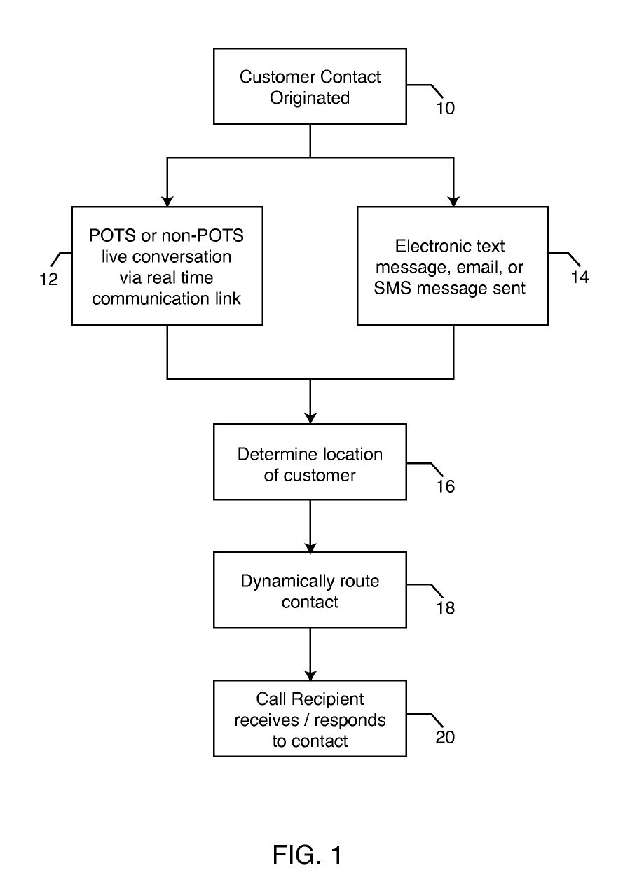

The present invention is generally illustrated in FIG. 1. First, a customer contact is originated (10). This can take many forms. In a particularly preferred embodiment, the contact is a plain old telephone service (POTS) telephone call through a public switched telephone network (PSTN), although the contact can be a non-POTS live conversation. Such communication is facilitated via a real-time communication link such as a satellite-enabled voice link, voice activated dialing link, VoIP link, or the like (12). An example of a satellite enabled contact or voice link is the service provided by OnStar™. Drivers or passengers in a vehicle press a button and are placed in contact with an OnStar™ operator. The user tells the operator of the desired goods or services and the operator helps the user obtain the goods and/or services. The system of the present invention would route the user to a call recipient providing the service or offering the goods. Of course, the customer initiated contact could also comprise an electronic message, such as a text message, e-mail or SMS message (14). Such an electronic message originates from a user computer, cell phone, personal digital assistant, vehicle navigation system device, or the like.

The location of the customer is then determined (16) via any one of a number of different methods. The geographic location of the user is automatically determined by customer telephone identification, GPS assisted location, triangulation, operator assisted location, or cell phone assisted location. Alternatively, the customer is prompted to provide relevant geographic location information. Customer input is automatically processed via speech recognition or keypad entry.

The customer contact is then dynamically routed (18) to a call recipient who receives or responds to a customer contact or request (20). The contact is dynamically routed according to the goods and/or services the customer desires, customer location, or a hierarchical call recipient contact list.

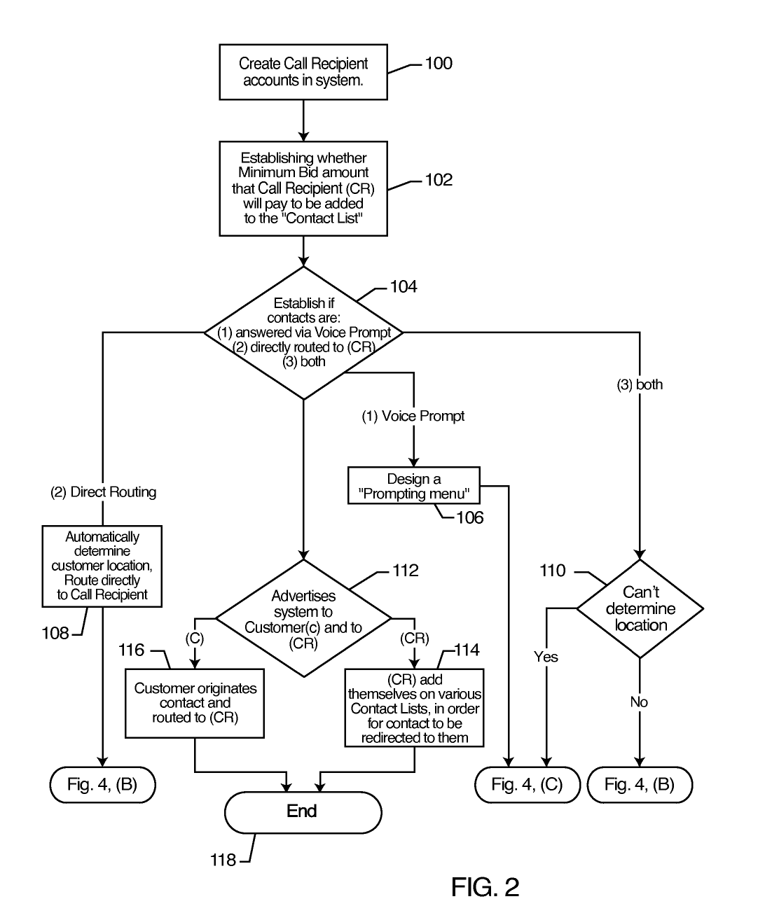

With reference now to FIG. 2, the contact routing system process of the present invention is first established. The system owner could serve as a host in a specific geographic location, nationwide, or through the Internet. The system owner could comprise a phone company (such as AT&T), an Internet company (such as Google), or any other company that sets up the system of the present invention to directly interact with a customer. Promoters (P), may also be used to create accounts in the system (100). That is, the promoter may negotiate a license to retain exclusive rights to a certain geographic territory or a certain type of call recipient (CR). The promoter creates an account with the host or system owner via the internet, by telephone, or by mail. The process of the present invention enables promoters to create a system that routes customer contacts to various call recipients based on the design of the contact routing business.

The promoter may deposit money into an account after creation thereof. Deposits are directly made by check, money order, or a credit account established with the host. Money may also be electronically debited by the host from the promoter's bank account. Alternatively, money is not initially required to be deposited into the promoter's bank account. The promoter may pay the host on a periodic basis, such as monthly, for contacts received and revenue share generated by the client or the call recipients' accounts. The promoter may pay the host after receiving the periodic bill (e.g., a monthly billing statement). The promoter may arrange for the host to automatically debit a bank account belonging to the promoter. Such automatic debits may also occur on a periodic basis.

The promoter may establish a minimum bid amount or listing fee that a call recipient pays for inclusion in the system on a contact list (102).

The promoter then establishes whether the received contacts are to be answered by a voice prompt, directly routed to a call recipient, or a combination thereof (104). For telephone call contacts, either the promoter or the host preferably owns a telephone number suggestive of a group of call recipients. Even more preferably, the telephone number is a toll free telephone number, such as a 1-800 or 1-866 telephone number. Other example telephone numbers may include 1-800 PLUMBER, 1-800-FLOWERS, 1-800-LAWYERS, etc. Typically, the promoter advertises the telephone number or other contact information and system services, such as geographic area, to both potential call recipients and customers. Advertising takes place on the internet, telephone directories, billboards, mass mailers, etc. Thus, call recipients do not need to have the sophistication or pay the fees necessary to maintain an internet presence. Potential customers do not need to own a computer or have internet access to become aware of the contact information for the group of call recipients ready to provide services. A suggestive toll free number is most desirable as potential customers will readily remember such telephone numbers. Accordingly, there is no need to reference additional materials when a service is needed. Rather, customers contact the number from memory. But, telephone numbers need not be toll free or suggestive. The contact information can also comprise information other than telephone numbers. Contact information may include website addresses, e-mail addresses, short codes, instant messenger names, or any other contact method known in the art. For example, satellite enabled communication is increasingly available to customers. A well known type of communication is the OnStar™ service, wherein vehicle drivers or passengers press a button to contact an OnStar™ operator. Operators currently provide accident or repair assistance, driving directions, and the like. In implementing the present invention with OnStar™, the vehicle driver or passenger could request a restaurant, a hotel, a mechanic, etc. in a given geographic location and be immediately routed to an available call recipient.

Referring again to FIG. 1, if the promoter establishes that the contacts are to be answered via voice prompt, the promoter designs a unique prompting menu to satisfy the specific business requirements (106). For example, if the potential customer calls 1-800-LAWYERS, a prompting menu may request that the potential customer select an area of law, such as intellectual property, real estate, family law, or criminal law. The system could be designed to receive such selection by speech recognition or by prompting the potential customer to press a certain button on the telephone keypad corresponding to the desired area of law. The prompting menu is typically conveyed to the customer immediately upon calling the telephone number and before the contact is routed to a call recipient, although the prompting menu can be provided after the contact is routed to a call recipient. Here, certain information is obtained by the particular call recipient before taking the telephone contact.

Alternatively, when a potential customer initiates a contact, the system is designed to identify the caller via contact identification. Contact identification includes a customer telephone number (108). The system detects the geographic location of the customer contact and generates an appropriate call recipient contact list. Preferably, the contact list is based on a specific geographic location. Alternatively, the system may identify the customer telephone number via caller I.D. The system stores information about the customer activity (i.e., category searches, requested results, etc.). The system uses the stored information to provide relevant advertisements or ordered call recipient listings. Such customer specific information stored via caller I.D. can also be used for other marketing purposes. Stored user information may be accessed to more easily reconnect a customer with call recipients previously contacted. In such an embodiment, the customer places an initial phone call to the system of the present invention and is connected to the highest bidding call recipient for a specific service. When placing a second call regarding the same service, the user is prompted to either connect to the previous call recipient or to connect with the next available call recipient.

In another alternative embodiment, the system of the present invention is capable of reordering the call recipient list based on the call history of the specific user. This reordered call recipient list still only includes available call recipients. But, this call recipient list specifically lists call recipients in an order that matches the user's previous call recipient searches and call recipient selections. In the same instance, the system may play relevant advertisements before conveying the call recipient list. The advertisement is based wholly or in part on the user's previous searches or selections. Such searches and selections may be combinable with an associated online account. For example, a website search engine may store telephone number information in an online account. The system of the present invention is capable of retrieving the online account information to match previous searches and selections online with the caller's telephone number. The online searches and selections are therefore combinable with information concerning the user's telephone-based searches and selections. The system processes such information to provide the user with the most relevant call recipient listings online or over the telephone. Moreover, users are able to access call history details online and easily reconnect with call recipients previously contacted. The corresponding online account may also display more information concerning the call recipient (e.g., location, email, website, telephone number, etc.). Additionally, the user may leave feedback concerning the call recipient and also conduct transactions, such as purchases, online or over the telephone.

The system is also designed to determine customer location when the caller identification is blocked (110). Initiating a voice prompt, connecting the contact with a customer service representative, or the like, are other suitable measures for determining customer location. Additionally, the present invention may also use satellites or other forms of geo-location to detect the location of the customer.

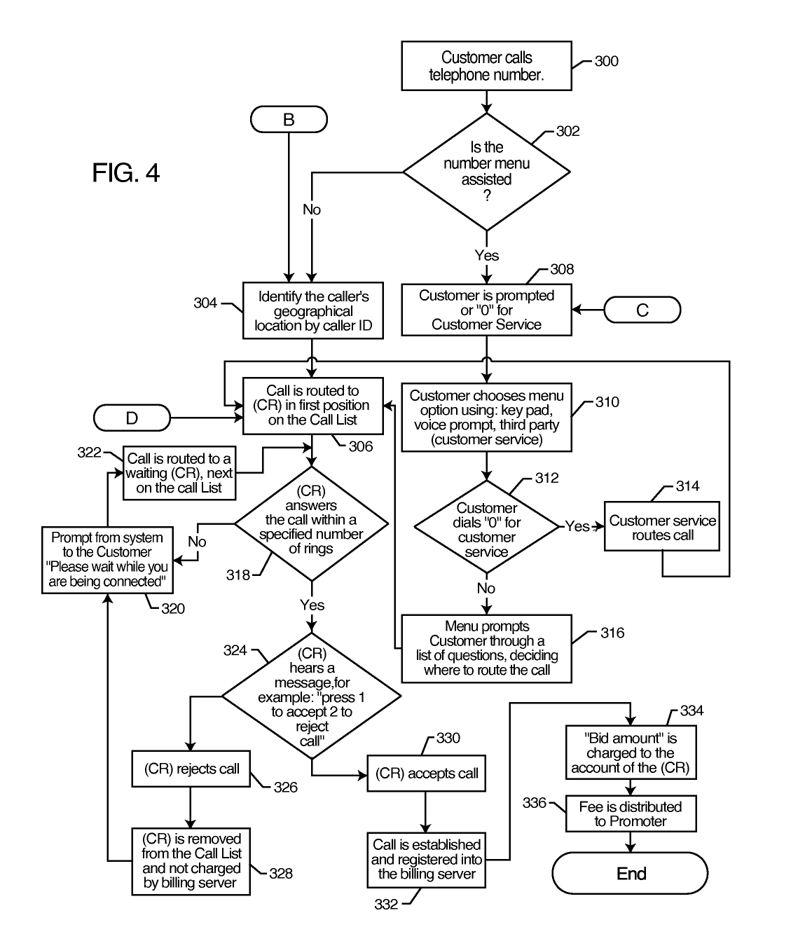

Once the promoter and/or host establish the menu driven software, the promoter advertises the contact routing system service. As discussed above, the promoter advertises the telephone number to potential customers and call recipients (112). A call recipient desiring to belong to the system can be added to various contact lists by registering over the phone. Customer contacts are thereafter directed to the customer (114). Of course, call recipients can contact the promoter and/or host via other methods, such as by visiting a website, calling the promoter, mailing or faxing the registration form to the promoter and/or host, etc. As is more fully illustrated in FIG. 4, the customer can contact a unique telephone number or other contact means to be directed to a call recipient (116).

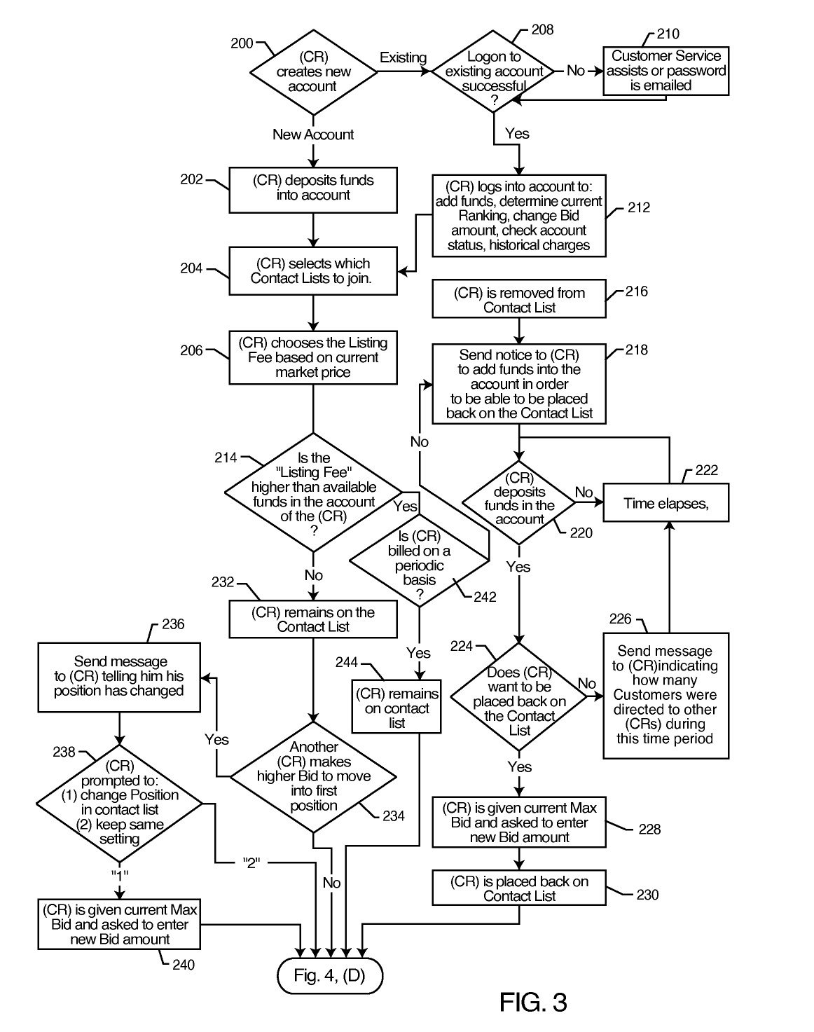

With reference now to FIG. 3, promoters of the present invention inform potential call recipients of the only obligation to pay the promoter and/or host when a potential customer contact is actually received. This payment method removes many of the uncertainties associated with listing a telephone number in a telephone directory or paying an internet advertiser for “hits”. The call recipient first creates a new account with the promoter and/or host (200). The account, at a minimum, identifies the call recipient and includes contact information such as telephone number, e-mail address, etc. The system uses the contact information to route customers to the call recipient. The call recipient then deposits funds into an account (202) such as by credit card, check, money order, etc. in the same and/or similar manner that the promoter deposits money into a similar bank account. Money may also be electronically debited by the promoter and/or host from a call recipient bank account.

After establishing an account, the call recipient selects contact lists to join (204). The system may be designed to automatically associate the call recipient with a particular contact list based on geographic location. In other instances, there may be no geographic territory limitations whatsoever and thus the call recipient is placed on a nationwide or statewide contact list. The call recipient may have multiple offices such that the call recipient can select multiple contact lists representing the multiple geographic locations where the offices are located. Furthermore, the call recipient may offer more than one type of service. For example, a call recipient law firm may provide representation in criminal law, real estate, litigation, etc., and thus be eligible for multiple contact lists within a single geographic location. The call recipient can also vary bid amounts based on these different geographic locations. Belonging to a particular contact list in one geographic area may be more valuable than belonging to another contact list in a second geographic area. For example, a contact list for a metropolitan area may be more valuable than a contact list for a rural area.

The call recipient then chooses the listing fee, where a per-contact charge fee is applied and based on an established minimum and/or current market price (206). Typically, a minimum per-contact fee is established by the promoter and/or host. This is a minimum per-contact charge for a customer contact received by a call recipient. For example, the minimum per-contact charge may be one dollar ($1.00) per contact.

In a particularly preferred embodiment of the present invention, call recipients bid against one another for a “high” bid per-contact amount. Call recipients can view, not only the minimum established per-contact listing fee, but also the maximum or highest bid on the contact list. Call recipients can also call a telephone number, such as a customer service number or the like, to retrieve such information. The contact lists are ranked from highest bidder to lowest bidder and customer contacts are routed accordingly. Thus, although the minimum listing fee per-contact charge may be one dollar ($1.00), the market price that the call recipients are willing to pay to obtain the highest ranking, and potentially receive the most customer contacts, may be much higher. For example, the highest bid may be two dollars ($2.00) or more per-contact. At this point, call recipients are able to select a per-contact charge and bid against other call recipients on the contact list. A call recipient that pays the highest bid amount moves to the first position on the contact list. Alternatively, a call recipient may pay a lower bid amount and retain lower priority on the contact list. The least amount of money that the call recipient can select is the established minimum bid amount. As customer contacts are routed to the call recipients, the per-contact charge is deducted from an established call recipient bank or credit account. The present invention also provides for certain call recipients that hold regular business hours, such as 8:00 a.m. to 5:00 p.m. The system will not route customer contacts to that call recipient before 8:00 a.m. or after 5:00 p.m. The system can also be designed to allow call recipients to place bids for certain times of the day. For example, contacts received between 8:00 a.m. and Noon receive the highest bids, while contacts received in the afternoon receive lower bids. A call recipient may be able to place a zero bid for non-business hours. Additionally, the call recipient can indicate which days of the week and what hours of the day the call recipient is available to receive contacts. Accordingly, customer contacts are not routed to an unavailable call recipient.

Each call recipient has access to an account by logging on through the internet, by telephone, etc. Preferably, the accounts are available through the internet such that the information is readily available to the call recipient. If login is unsuccessful, a customer service representative can assist the call recipient. User name and password can be electronically mailed to the call recipient (210).

After logging into the account, the call recipient can add funds to the bank account, determine current bid ranking, increase bid amounts per contact, check account balances, check historical charges and contacts, and otherwise check the account status (212). Thus, the per-contact charge bids are preferably constantly alterable, even after account registration. In this manner, call recipients can change rank on the contact list at any time. The free market determines the upper price per-contact received, thereby maximizing the promoter and/or host revenue. Call recipients also retain control regarding the number of contacts received.

The call recipient is removed from the contact list (216) if the “listing fee” or bid amount is higher than the available funds in the account of the call recipient (214). A notice of insufficient funds is thereafter sent to the call recipient. The call recipient is invited to add additional funds to the account to be placed back on the contact list (218). Such notice may be automated, such as by an electronic mail message, instant message, telephone message, post card, or the like. The call recipient may then add additional funds to the account (220) by authorizing a credit card transaction, sending a check, or providing another means of payment to the promoter and/or host. If the call recipient does not deposit funds into the account after a pre-determined time (e.g., 2 days), an additional notice is sent to the call recipient to add funds to the account for placement back on the contact list (218). Messages are preferably sent to the call recipient displaying the number of customers directed to other call recipients. Such messages are used to persuade the call recipient to re-register with the system (226). If the call recipient wants placement back on the contact list, the call recipient is given the maximum or highest bid and asked to enter a new bid amount or select the established minimum bid amount (228). After bid selection, the call recipient is placed back on the list (230). Once on the contact list, the call recipient is routed customer contacts in accordance with the present invention. The call recipient remains on the contact list (232) while bids are lower than the available account funds.

Alternatively, the call recipient may open a periodic billing account. In a preferred embodiment, the call recipient is billed on a monthly cycle (242) and thus remains on the contact list (244) even with insufficient account funds to accommodate the total outstanding bids. The call recipient pays the promoter and/or host after receiving the periodic bill. The call recipient arranges for the promoter and/or host to automatically electronically debit a bank account or credit card account belonging to the call recipient on a periodic basis. As previously described the call recipient may access the account and periodically add funds as necessary. The call recipient may also determine current ranking and increase bid amounts. When a call recipient submits a higher bid and moves into a position above other call recipients or when a new call recipient takes over the highest ranking position on the contact list (234), a message is sent to all other call recipients, then having a lower ranking, with information concerning the change in position (236). The message is sent automatically by electronic mail, instant message, telephone voice mail message, or any other comparable form of electronic communication known in the art. Accordingly, the call recipient is prompted to increase relevant bid amounts to obtain a higher position on the contact list, although the call recipient may do nothing and stay in the lower position (238). The message may provide the call recipient with the current maximum bid amount and may request the call recipient to enter a new bid amount (240). For example, when registering, the call recipient may provide a credit card or bank account number that is automatically debited by the promoter and/or host per instructions of the call recipient. A speech recognition or window driven portion of the message enables call recipients to deposit additional funds into the account to cover any inadequate balances or to increase bid amounts per-contact received. Here, the call recipient is not required to log into the account to establish these tasks. The automated system then informs the call recipient of the account balance and the new minimum bid. Such steps are accomplished with an interactive speech recognition driven menu if a telephone message is directed to the call recipient or if the call recipient contacts a promoter and/or host customer number. Such steps can also be accomplished through electronic mail, instant messaging, or by logging into the call recipient account. Of course, the promoter and/or host may employ operators or customer service representatives to handle account requests.

With reference now to FIG. 4, the process for routing a customer initiated contact in the form of a telephone call is illustrated. First, a potential customer calls a listed telephone number. The telephone number is preferably a toll free number, as described above, but may also include local or long distance numbers, special 1-900 numbers, or any other appropriate telephone number (300). The system then determines if the number is menu assisted or needs menu assistance (302). As outlined above, VoIP is another route for customers calling into the network to be connected with call recipients. Alternatively, calls can be completely routed through PSTN, partially through PSTN, or not routed through PSTN at all. For example, a customer initiates a call using PSTN and is later routed to the call recipient via VoIP. If the system is set up to identify the geographical location of the customer by caller identification (304), then the call may automatically be routed to the call recipient in the first or highest ranked bidding position on the call list (306) for that specific geographic area. Other calls may automatically be routed to the call recipient in the first position on the call list without identifying the location of the telephone caller.

If the telephone number is menu assisted, because the caller identification is blocked or by system design, the customer is prompted to make a selection from various options or to choose to connect to customer service. The customer may depress the “0” button on the telephone keypad or verbally request customer service. The menu system may be set up according to the geographic location of the customer or the geographic location of the service to be provided. The customer can enter relevant location information such as the area code, zip code, city, state, etc. by speech recognition or keypad entry. Alternatively, the customer can narrow the call recipient search by quality or competition. Narrowing a searchable category by geography, quality, or competition occurs before the customer is routed to a call recipient. The customer may make other verbal or telephone keypad (308) entries for other selections, such as service type. For example, the customer may be asked for a rental car type. The customer can select luxury, compact, minivan, etc. Selection may occur before the call or after the call is routed and before the call recipient answers the telephone as discussed above (310).

If the customer has difficulty with the menu selection, the customer dials “0” for customer service (312) or otherwise requests customer service by speaking into the telephone. A customer service representative routes the call (314) to the call recipient in first position on the call list (306). Alternatively, the customer is asked a series of questions from the menu if customer service is not selected. From these questions, the system decides where to route the call (316). Accordingly, the call is routed to the call recipient in the first position on the appropriate call list (306).

In an alternative embodiment, the customer dials a 411 type telephone number and selects a category or verbally inputs a keyword or phrase. Instead of being routed to the highest bidder, the customer is presented with a list of call recipients. For example, the customer may be prompted to “press 1 for Joe's Plumbing”, “press 2 for Mike's Plumbing” or “press 3 for Gary's Plumbing”. The customer verbally selects a call recipient or otherwise presses the corresponding button on the telephone keypad regarding the desired call recipient. Thereafter, the system routes the customer to the specific call recipient. In one embodiment, an audio list is conveyed to the customer based on bid amount. That is, the highest bidding call recipient is the first call recipient on the list. In the previous example, “Joe's Plumbing” would be the highest bidding call recipient. Ultimately, call recipients “bid up” to receive a lead for a potential service while other call recipients “bid down” to actually perform the service. In an alternative embodiment, the list of call recipients includes a mixture of bidding call recipients and non-bidding call recipients. For example, the first one or two audio results may include call recipients that bid to place the advertisement. The rest of the call recipients following the first two call recipients are non-bidding call recipients. Hence, the remaining call recipients are listed for free. Such an embodiment is similar to a Google search results web-page wherein the first set of links are from sponsored advertisers while the remaining links are matched according to the search criteria.

In another embodiment of the present invention, the customer may receive a series of advertisements in association with accessing the system of the present invention. For example, the system may deliver a relevant advertisement or series of advertisements to a customer selecting a category within a 411 type system. The order the advertisements are conveyed to the customer is based on bidding. That is, the highest bidding call recipient advertisement is conveyed to the customer first. The system may also allow call recipients to customize the conveyed advertisements. For example “Joe's Plumbing” may supplement an advertisement with a slogan or tag line such as “Joe's Plumbing is the best, we have been in business since 1980”. The advertisement may also include a description of the goods and/or services. Simultaneously, the system is also capable of sending the customer any form of electronic information via text, voice, picture, or MMS. The ordering of the advertisements depends on the algorithm set up by the promoter and/or host. The algorithm may take into consideration other qualities such as calls missed, satisfaction rating, bid, length of calls, reputation, price, etc.

If the customer has difficulty with the menu selection, the customer dials “0” for customer service (312) or otherwise requests customer service by speaking into the telephone. A customer service representative routes the call (314) to the call recipient in the first position on the call list (306). The customer is asked a series of questions from the menu if customer service is not selected. From these questions, the system decides where to route the call (316). Accordingly, the call is routed to the call recipient in the first position on the appropriate call list (306).

The present invention also utilizes a “search engine” like an automated telephone system similar to dialing a 411 operator. In this embodiment, call recipients are categorically ranked based on industry and/or geographic location. In operation, the customer calls a telephone number with a phone inquiry. Upon connection, the customer verbally conveys a keyword or phrase (e.g., plumber, entertainment lawyer, etc.), or otherwise enters a keyword or phrase via a telephone keypad, other QWERTY keyboard, or according to the methods and processes disclosed in U.S. Ser. No. 60/939,388, filed May 22, 2007, entitled TELEPHONE SEARCH ENGINE, the contents of which are herein incorporated by reference, for connection with a call recipient. The system of the present invention then connects the customer with the highest bidding call recipient relating to that specific keyword or phrase inputted by the customer. Alternatively, the system uses an algorithm to rank the potential call recipients falling within the scope of the inputted keyword or phrase. The system may then either connect the customer directly with a call recipient or simply convey a call recipient list regarding the customer's keyword or phrase search. The system may convey the call recipient list verbally over the telephone, via text message, instant message, SMS, or any other method of conveying information known in the art. In an alternative embodiment, the system conveys an advertisement to the customer prior to conveying the call recipient list. The advertisement is conveyed in an order based on bid (relating to the specific keyword or phrase) or according to an algorithm designed by the system administrator. The advertisement may be conveyed verbally, visually, or as a text message. Moreover, call recipients and/or advertisers bid on key words or phrases rather than specific pre-set categories. Billing for connections with call recipients or conveying advertisements may be based on a bid amount per advertisement/call recipient connection or a fixed rate per advertisement/customer connection. Alternatively, the customer is not directly connected with the call recipient. The system only conveys call recipient contact information to the customer (e.g., audibly via the telephone, visually via SMS, text message, etc.). Here, the customer is billed by tracking the customer's telephone number in association with the call recipient's contact information. Alternatively, the call recipient may be billed every time the call recipient's contact information is conveyed, or the call recipient may be charged a flat fee to be a part of the service of the present invention.

The customer is then routed to an industry of specific call recipients by speaking into the phone, entering information by a phone keypad, or conveying information by another comparable medium. The search results may be conveyed to the customer individually, as previously described, or presented in groups. The system may convey the first five search results in one group and ask that the customer “press 1 to hear the next 5 search results”. The search results are returned to the customer via audio, text message, or any other electronic method of communication known in the art. For example, the system sends a text message to the customer in response to a request for “plumbers” in “Beverly Hills, Calif.”.

Once the call is routed to the call recipient, the call recipient must answer the call within a specified number of rings, such as 3 or 4 rings. If the call recipient does not pick up, the system may prompt the customer to please wait, while you are being connected (320) and simultaneously routes the customer to the next call recipient on the call list (322).

If a call recipient is unavailable (e.g. on another telephone call or on vacation), the customer is immediately routed to another call recipient without leaving a message with the first call recipient. This enables lower ranking call recipients to receive customer calls as well, although the highest ranking call recipient receives the most customer calls.

A call recipient answers the call within a specified number of rings (318) and is either presented with a live customer call or automated message. Automated messages may ask the call recipient, for example, to “press 1 to accept” or to “press 2 to reject” the phone the call. The call recipient may also voice acceptance or rejection of the phone call. Voice responses are interpreted by speech recognition software or the like (324). The call recipient is typically removed from the calling list and not charged by the billing service (328) if the call recipient rejects the call. Alternatively, the system may not remove the call recipient from the call list. Instead, the call recipient selectively accepts or rejects calls until the account balance falls below the minimum bid of the call recipient. The call recipient may also close the account and thereafter be removed from the contact list. In each embodiment, the system routes the call to the next highest ranking call recipient on the call list (322).

The highest ranking call recipient may accept a customer call by verbal expression, pressing a telephone button, or by merely answering a telephone call (330). The call is then established and registered into the billing server (332). The call recipient per-call “bid amount” is thereafter charged to the account of the call recipient (334). Preferably, the per-call charge bid amount is automatically deducted from the account of the call recipient. Alternatively, call recipients using post-paid accounts are billed on a periodic basis. The fee is then distributed to the promoter (336).

Even though the above-provided description relating to FIG. 4 is related to a customer initiated contact in the form of a telephone call, such as a cell phone or a POTS “land line” call, the present invention is not limited as such. Other forms of routing, besides telephonic calls, are also compatible with the present invention. For example, live voice conversations are facilitated via the internet, VoIP, satellite enabled uplinks (such as OnStar™, automated dialers (including pre-programmed telephone or contact numbers) and any other system that does not require the potential customer to dial an actual telephone number, such as surfing the Internet, using a web browser, or using any other type of mobile or cell phone browser-enabled application. An example is provided in U.S. Pat. No. 7,076,037 to Gonen et al., entitled PROCESS FOR DYNAMIC CALL ROUTING, the contents of which are herein incorporated by reference. Dynamic routing of non-voice based customer contacts, such as an electronic message, including text messages, SMS messages, e-mail messages, and the like, are also compatible with the present invention. For example, an e-mail initiated customer contact is routable to a call recipient e-mail address, telephonic device, SMS device, or the like. Similarly, an SMS or text message initiated customer request is routable to a call recipient SMS device, telephonic device, or the like. The call recipient can respond by electronic message, or otherwise contacting the potential customer. The steps illustrated in FIG. 4 are also applicable to each of the above-described communication methods.

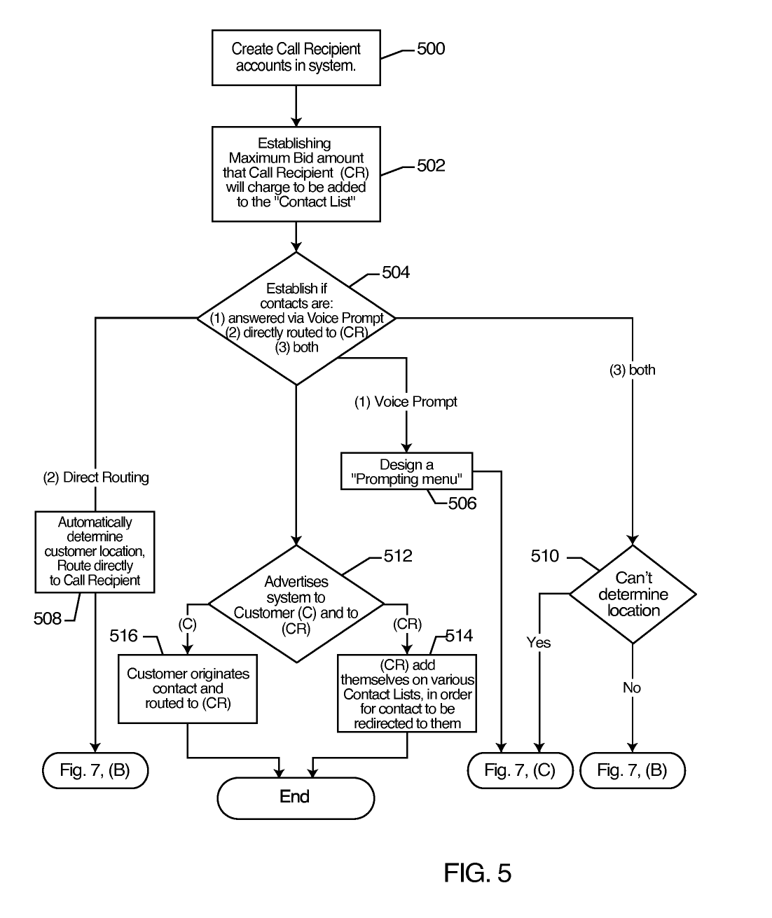

As generally illustrated in FIGS. 5-7, another embodiment of the present invention enables call recipients from all over the world to place minimum bids to provide advice, goods, and/or services to customers. For example, a promoter and/or host operates a telephone line (e.g. 1-800-ADVICE, 1-800-ROSES, 1-800-LAWYERS, etc.) or website (www.advice.com, www.roses.com, www.lawyers.com, etc.) that provides goods and/or services. A customer calls 1-800-ADVICE, 1-800-ROSES, 1-800-LAWYERS, etc. or accesses a promoter and/or host website to obtain goods and/or services. The customer is routed to the lowest bidding call recipient to provide that good or service to the customer on behalf of the promoter and/or host. Here, the call recipient is an independent sub-contractor working for the promoter and/or host. The customer is routed to the call recipient willing to be paid the least amount of money to provide the desired services on behalf of the promoter and/or host.

A customer is charged a flat fee for a call (e.g., $2.00 per call or $20.00 for a bouquet of roses) or charged a variable fee based on the call recipient bid (e.g., $2.00 per minute). Customers are charged directly by the promoter and/or host. In turn, the provider and/or host pays the call recipient the corresponding bid amount. The promoter can earn money (i.e., increase profits) through competitive “down bidding” (i.e., a minimum price per-call that call recipients accept as compensation for performing or providing a service). Upon completion of the service rendered by the call recipient, the promoter and/or host pays the call recipient by depositing the bid into a corresponding bank account (e.g., $0.50 per minute or $5.00 for a bouquet of roses). The promoter and/or host keeps the profit (e.g., $1.50 per minute for the call or $15.00 for the bouquet of roses). This enables the customer to hire the most competitive call recipient having the lowest rate to accomplish the desired service. Call recipients are only paid by the promoter and/or host when a potential customer contact is actually received and the goods and/or services are provided to the customer. This embodiment removes many uncertainties associated with listing a telephone number in a telephone directory or paying an internet advertiser for “hits” that do not generate revenue.

In FIG. 5, the contact routing system comprises the present invention as first established. The system owner could serve as a host in a specific geographic location, nationwide, or through the Internet. The system owner could comprise a phone company (such as AT&T), an Internet company (such as Google), or any other company that sets up the system of the present invention to directly interact with a customer. Promoters (P), may also be used to create accounts in the system (500). That is, promoters may license specific geographic territories or specific services. The promoter creates an account with the host or owner of the system via the internet, telephone, or even mail. The process of the present invention allows the promoter to create a system that routes customer contacts to various call recipients based on unique routing algorithms developed by individual promoters.

The promoter deposits money into an account after creation. Promoters deposit money via check, money order, or credit card, such that the promoter establishes a credit line with the host. Alternatively, the promoter may not deposit money into the account. Rather, the promoter pays the host on a periodic basis (e.g. monthly) for contacts received and generated revenue share.

The promoter may establish a maximum bid amount or fee that a call recipient shall be paid for inclusion on a contact list (502). The promoter and/or host sets the maximum bid for connecting the customer with the call recipient. To maximize profit, the promoter and/or host should seek low bidding call recipients.

The promoter then establishes whether the received contacts are answered by a voice prompt, directly routed to a call recipient, or a combination thereof (504). For telephone call contacts, the promoter and/or the host preferably owns a telephone number suggestive of the group of call recipients. More preferably, the telephone number is a toll free number, such as a 1-800 or 1-866 telephone numbers. For example, telephone numbers may include 1-800-PLUMBER, 1-800-FLOWERS, 1-800-LAWYERS, etc. Typically promoters advertise the telephone number or the contact information. Advertisements may be based on geographic area or by specific service. Advertising notifies both potential call recipients and customers of the system and services. Such advertising takes place via the internet, telephone directories, billboards, mass mailers, etc. Thus, call recipients do not need to maintain an internet presence. Moreover, potential customers do not need to own a computer or have internet access to be notified of the system and corresponding call recipient contact information. A suggestive toll free number is preferable as potential customers are likely to remember such telephone numbers and need not reference additional materials when a particular service is needed. Accordingly, customers are able to easily recall the contact number from memory, although the telephone numbers need not be toll-free nor suggestive. The contact information may also comprise information other than telephone numbers. Information may include website addresses, e-mail addresses, or any other comparable contact information known in the art. For example, satellite enabled communication is increasingly available to customers. OnStar™ is a well known satellite enabled communication service. Vehicle drivers or passengers contact an OnStar™ operator by pressing a button in the vehicle. OnStar™ currently provides accident or repair assistance, driving directions, and the like. The vehicle driver or passenger could access the OnStar™ operator to request a restaurant, a hotel, a mechanic, etc. in a specific geographic location according to the routing system of the present invention.

The promoter may establish that contacts are to be answered via voice prompt. The promoter must design a unique prompting menu to suit the specific business requirements (506). For example, if a potential customer calls 1-800-LAWYER, a prompting menu may request that the potential customer select an area of law, such as intellectual property, real estate, family law, or criminal law. The system could be designed to receive selections by speech recognition or by prompting the potential customer to press a button on the telephone keypad. The prompting menu is typically provided to the customer upon calling the telephone number and before the contact is routed to a call recipient, although the prompting menu may also be provided after a contact is routed to a call recipient. In this embodiment, certain information may be obtained by the call recipient before accepting the telephone contact.

Alternatively, when a potential customer initiates contact with the system, the caller is identified by some form of contact identification such as a customer telephone number (508). In this manner, the system tracks the geographic location of the customer and creates an appropriate call recipient contact list. Preferably, the call recipient contact list is based on geographic location. Alternatively, the system is designed to identify the customer with the call identification (510). Other measures are taken to determine the location of a customer, such as initiating a voice prompt, connecting the contact with a customer service representative, or other comparable method known in the art.

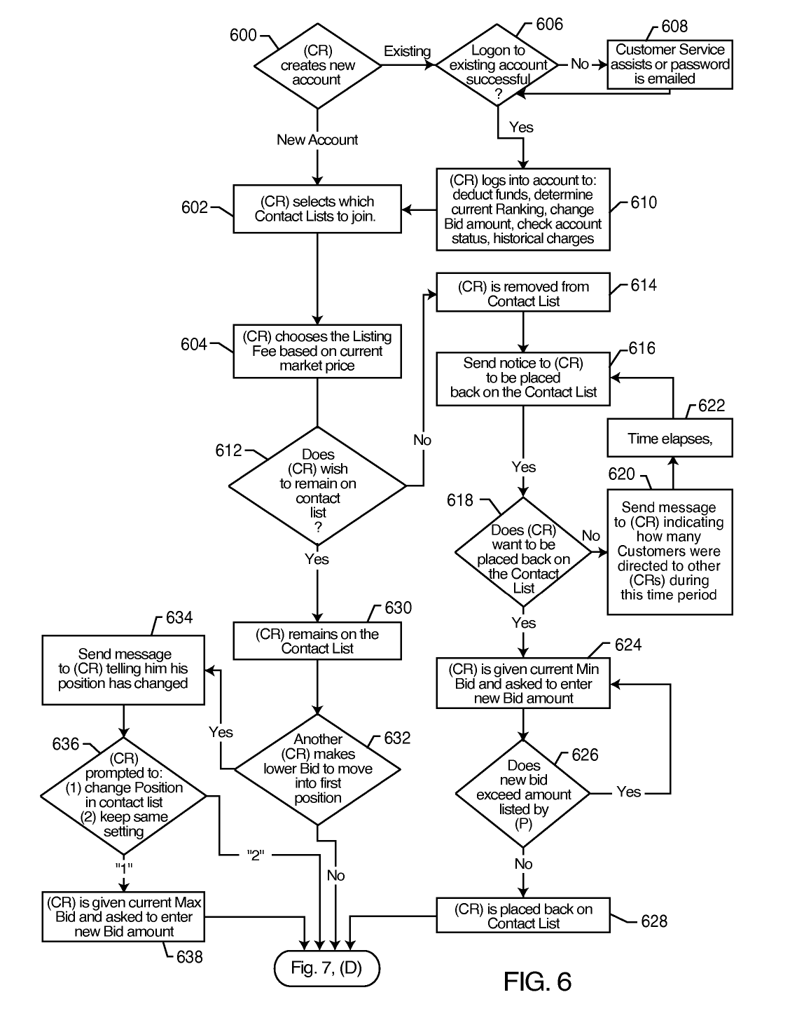

The promoter advertises the contact routing system services once the promoter and/or host establishes the menu driven software. As discussed above, the promoter advertises a telephone number to potential customers and call recipients (512). A call recipient may register with the system over the phone. After registration, the call recipient may join various contact lists to have customer contacts directed to them (514). Of course, call recipients may contact the promoter and/or host by other methods known in the art. For example, the call recipient may utilize websites, the telephone, the mail, or facsimile to register with the promoter and/or host. The customer may also contact a unique telephone number or other comparable contact means to be directed to a call recipient (516), as is more fully described in FIG. 6.

The call recipient first creates a new account with a promoter and/or host (600), as illustrated in FIG. 6. The account, at a minimum, identifies the call recipient and includes contact information such as a telephone number, an e-mail address, etc. The contact information is used to route customer contacts directly to the call recipient. The promoter and/or host only deposits funds into the call recipient account by check or credit card. Deposits occur after a contact is made between the customer and the call recipient and after the goods and/or services are provided to the customer. The call recipient selects a contact list to join (602) after establishing an account. The system may automatically associate the call recipient with a particular contact list based on geographic location. Alternatively, the call recipient is not restricted geographically. In this embodiment, the call recipient is able to join a nationwide or statewide contact list. For instance, the call recipient may have offices in multiple locations. Accordingly, the call recipient can join multiple contact lists representing the multiple geographical locations where the offices are located. Furthermore, the call recipient may offer multiple services. For example, a call recipient law firm may provide representation in criminal law, real estate law, litigation, or intellectual property law. Thus, the call recipient is eligible to join multiple contact lists, even within a single geographic location. The call recipient is also able to place various bid amounts for each individual list. Belonging to a particular contact list in one geographic area may be more valuable than belonging to another contact list in another geographic area. For example, a contact list in a metropolitan area may be more valuable than a contact list in a rural area.

The call recipient then chooses a minimum charge to provide the goods and/or services. The charge is based upon an established minimum, maximum and/or current market price (604). The promoter and/or host lists the call recipients in an order from those charging the lowest rate to those charging the highest rate. The promoter and/or host may choose to establish a cap whereby goods over the cap are excluded from the listing. The highest contact list priority is given to the call recipient with the lowest charge. Typically, transaction charges or contact charges are established by the promoter and/or host. The promoter and/or host charges the customer a flat fee for the contact or charges the customer a variable fee based on the bid. A minimum per-contact charge for call recipient contacts may also be applicable. For example, a per-contact charge may be one dollar ($1.00) per contact or a fixed percentage of the bid. Alternatively, charges may include a percentage of the value of the goods and/or services performed. The call recipient is paid according to the bid (e.g., $14.00 for performing two hours of work at $7.00 per hour). The promoter charges the customer more than the call recipient bids. Even though the customer may decide not to obtain the goods and/or services from the call recipient, the promoter and/or host may still charge the customer a fee (flat or variable) for the established contact between the customer and call recipient.

In a particularly preferred embodiment of the present invention, call recipients bid against one another for a “lowest” bid per-contact or transaction amount. Call recipients can view not only minimum established per-contact listing fees, but also the lowest bid on the contact list. Call recipients can also call a telephone number, such as a customer service number or the like, to retrieve this information. The contact list ranks call recipients from lowest bidder to highest bidder. Customer contacts are routed accordingly. Thus, the market dictates the price call recipients are willing to offer to obtain the lowest ranking, in terms of costs to the promoter and/or host, to potentially receive the most customer contacts. The call recipient may select a minimum bid amount acceptable as payment for the goods and/or services provided to bid against the other call recipients on the contact list. Selecting the lowest bid amount places the call recipient in the first position on the contact list. Selecting a higher bid amount lowers the call recipient priority on the list. The promoter and/or host establishes the maximum bid a call recipient may place. The call recipient is never charged by the promoter and/or host for a contact from a customer. Rather, the customer pays the host and/or promoter.

The present invention contemplates that certain call recipients may hold regular business hours such as 8:00 a.m. to 5:00 p.m. Thus, customer contacts are not routed to that call recipient before 8:00 a.m. or after 5:00 p.m. The system is designed to enable call recipients to place bids for certain times of the day. For example, contacts received between 8:00 a.m. and Noon may receive lower bids than contacts received between Noon and 5:00 p.m. The call recipient can also place a no-bid for non-business hours. Additionally, the call recipient can place bids for specific days. Call recipients may choose which hours during those days that the call recipient is available to receive contacts. Customer contacts are not routed to an unavailable call recipient.

Each call recipient has access to an account by logging on through the internet, by telephone, etc. Preferably, the accounts are available through the internet such that the information is readily available to the call recipient through a provider and/or host website (606). If login is unsuccessful, a customer service representative can assist the call recipient. The user name and password can be electronically mailed to the call recipient (608).

After logging into the account, the call recipient can deduct funds from the account, determine current bid ranking, increase or decrease bid amounts per-contact, check account balances, check historical payments and contacts, and otherwise check the account status (610). Thus, the charge amount per-contact bids are preferably constantly alterable even after account registration. In this manner, call recipients can view or change rank by accessing the contact list. The free market determines the lowest price per-contact per transaction received, maximizing the promoter and/or host revenue. Call recipients also retain control regarding the number of contacts received. The call recipient can arrange to deposit funds into a bank account when the promoter and/or host pays the call recipient. Payment occurs via check, electronic transfer, or the like.

The call recipient remains on the contact list (612) until removed. In one embodiment the call recipient requests removal from the contact list (614). Thereafter, notice is sent (616) to the call recipient to determine if the call recipient wants placement back on the contact list (618). The call recipient receives a message from the system indicating the number of missed customer contacts during contact list removal. The message is used to persuade the call recipient to re-register with the system (620). This message is sent to the call recipient periodically (622). The call recipient receives a minimum or lowest bid upon placement back on the contact list. Thereafter, the call recipient is asked to enter a new bid amount or select the established minimum bid amount (624). The call recipient may not bid higher than the maximum amount listed by the promoter and/or host for the goods and/or services (626). The call recipient is placed back on the list (628) pending the call recipient does not bid higher than the maximum allowable bid amount. Once back on the contact list, the call recipient is routed customer contacts in accordance with the present invention.

When the current call recipient bid is higher than the amount charged by the promoter and/or host, the call recipient is prompted to re-bid in order to be placed back on the contact list (624). Alternatively, the promoter and/or host may keep the call recipient in an inactive, yet open account. The call recipient may be paid on a periodic basis (e.g. monthly), pending the account is active.

The call recipient may access a bank account to periodically deduct funds as necessary. Additionally, the call recipient may access its current ranking and increase bid amounts. The call recipient remains on the contact list (630) while maintaining an active account as previously described. If a call recipient submits a lower bid to move into a position ahead of the other call recipients concerning priority on the contact list, a message is sent to the other call recipients with information concerning the change in position (634). This call recipient would now have the highest ranking position on the contact list in terms of having the lowest bid for providing the goods and/or services (632). The message sent to the other call recipients is automatically generated by electronic mail, instant message, telephone voice mail message, etc. The call recipient is prompted to decrease relevant bid amounts to obtain a higher position on the contact list, although the call recipient may do nothing and stay in the lower priority position and charge a higher amount to provide the goods and/or services (636). The message conveys the current minimum bid amount and asks call recipients to enter a new bid amount (638). The call recipient may have a bank account set up to receive automatic deposits from the promoter and/or host. A speech recognition or window driven portion of the message may allow the call recipient to transfer additional funds from the promoter and/or host account and into a separate bank account. The call recipient is not required to login online to accomplish this task. The automated system can directly inform the call recipient of account balances. Such steps are accomplishable via an interactive speech recognition system, electronic mail, instant message, or by accessing the call recipient account. Of course, the promoter and/or host may employ operators or customer service representatives to receive responses to account requests.

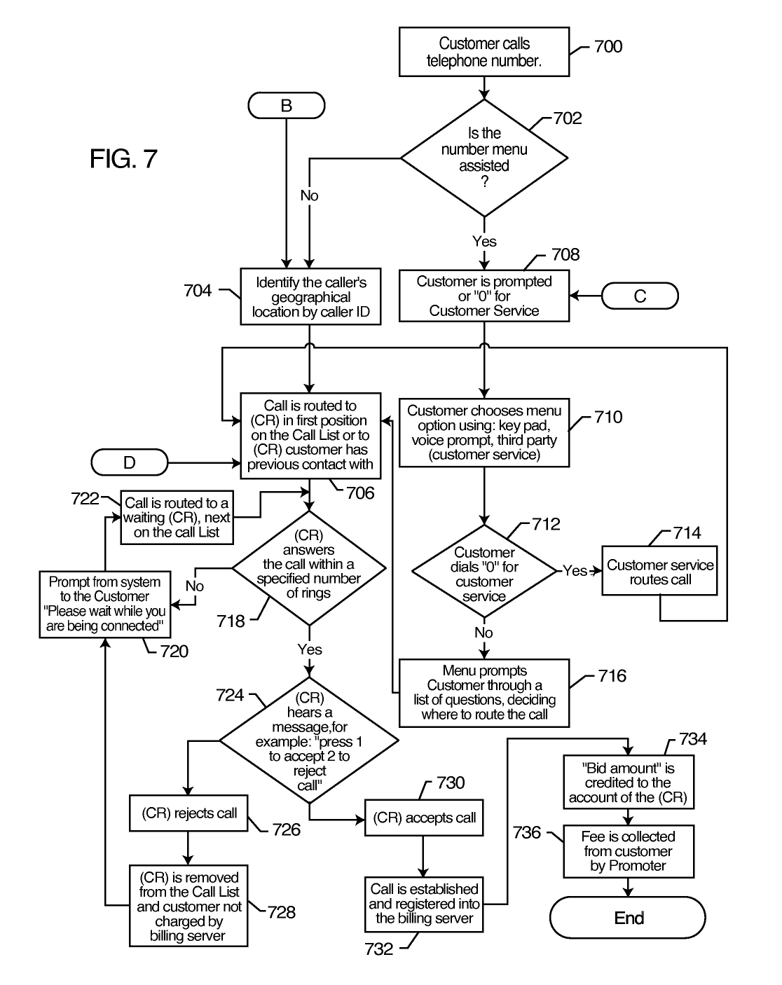

FIG. 7 illustrates the process for routing a customer initiated contact in the form of a telephone call. A potential customer calls the system telephone number, preferably a toll free number or other local telephone number, a long distance number, a special 1-900 number, or any other appropriate telephone number (700). The system determines if the number is menu assisted or needs menu assistance (702). VoIP provides another route for customers calling into the network to be connected with call recipients. Calls can be completely routed through PSTN, partially routed through PSTN, or not routed through PSTN at all. For example, a customer initiates a call using PSTN, but is later routed to the call recipient via VoIP. If the system is set up to identify the geographical location of the customer by caller identification (704), then the call may be automatically routed to the call recipient in the first or highest ranked bidding position on the call list (706). Other calls may be automatically routed to the call recipient in the first position on the call list without identifying the customer location.

If the telephone number is menu assisted, because the caller identification is blocked or by system design, the customer is prompted to make a selection from various options or to choose to connect to customer service. The customer may depress the “0” button on the telephone keypad or verbally request customer service. The menu system may be set up according to geographic location of the customer or the geographic location of the service to be provided. The customer can enter relevant location information such as area code, zip code, city, state, etc. by speech recognition or keypad entry. The customer may make other verbal or other telephone keypad (708) entries for other selections, such as service type. For example, the customer may be asked for a rental car type. The customer can select a luxury, compact, minivan, etc. vehicle. Selection may occur before the call or after the call is routed and before the call recipient answers the telephone as discussed above (710).

The customer may dial “0” for customer service (712) or otherwise request customer service by speaking into the telephone. Thereafter, the customer service representative routes the call (714) to the call recipient in the first position on the call list (716). Alternatively, the system routes the call (716) when the customer responds to a list of questions provided by the system. The call recipient in the first position on the appropriate call list (706) receives the call. Alternatively, the system may route the customer to a call recipient the customer previously contacted. There are many different methods of routing calls within the scope of the present invention. The system may account for missed calls, satisfaction rating, bid (minimum rate or amount), call length, reputation, cost, etc. to determine call routing. Additionally, it is possible to audibly list call recipients to the customer. The listing incorporates an algorithm based on the aforementioned criteria. Moreover, the system may randomly select call recipients or select call recipients based on round robin. Alternatively, a certain percentage of calls may be routed to the highest priority bidding call recipient (i.e., the lowest bidder), while another percentage of calls are routed to the call recipient with the next highest priority and on down the bidding line of the contact list.

The present invention also incorporates a “search engine” like automated telephone system similar to dialing a 411 operator. In this embodiment, call recipients are categorically ranked based on industry and/or geographical location. In operation, the customer calls a telephone number with a phone inquiry. The customer is then routed to an industry of specific call recipients by speaking into the phone, entering information via a telephone keypad, or conveying information via another comparable method. This “search engine” facilitates real-time connectivity between the customer and call recipient. For example, a call recipient endeavoring to sell a 2003 Honda Accord places a classified advertisement within the system of the present invention. The call recipient pays the promoter and/or host a certain fee for each customer contact pursuant to the advertisement. The call recipient pays a fee to the promoter and/or host based on any one of a number of criteria, as previously discussed. For example, the promoter and/or host may set a flat fee, or a minimum fee, payable by the call recipient. Alternatively, the call recipient may pay the promoter and/or host a bidded fee. When call recipients bid on certain fees, the present invention routes potential customer contacts to the highest bidding call recipient. For example, a first call recipient endeavoring to sell a 2003 Honda Accord places a bid of fifty cents ($0.50) per contact. This call recipient has a higher routing priority than a second call recipient, also selling a 2003 Honda Accord, that bids forty cents ($0.40) for the customer contact, although competition is not necessarily limited by the highest bid. The promoter and/or host may create an algorithm to consider other parameters such as geographic location, missed calls, satisfaction rating, number of bids, call length, reputation, costs, etc. In effect, this classified on demand system bridges call recipients and customers in a telephonic market place. In this example, call recipients sell goods rather than provide services.

The call recipient must answer a call within a specified number of rings, such as 3 or 4 rings (718) once the call is routed to the call recipient. If the call recipient does not pick up, the system may prompt the customer to “please wait, while you are being connected” (720). The system then routes the call to the next call recipient on the call list (722). If a call recipient is unavailable (e.g. on another telephone call or on vacation), the customer is routed to another call recipient without leaving a message with the first call recipient. This enables lower ranking call recipients to receive calls, although the highest ranking call recipient receives the most customer calls.

A call recipient that answers the call within a specified number of rings (718) is either presented with a live customer call or automated message. Automated messages may ask the call recipient, for example, to “press 1 to accept” or to “press 2 to reject” the telephone call. Voice responses may also accept or reject the phone call and are interpreted by speech recognition software or the like (724). If the call recipient rejects the phone call (726), the call recipient may be removed from the calling list and the customer is not charged by the billing server (728). Alternatively, the system may not remove the call recipient from the call list, but instead the call recipient selectively accepts or rejects calls until the call recipient closes the bank account. In this event, the system routes the call to the next highest ranking call recipient on the list (722).

The highest ranking call recipient accepts a customer call via verbal acceptance, pressing a button on the telephone keypad, or merely answering the telephone call (730). The call is then established and registered into the billing server (732). The call recipient per-call “bid amount” is thereafter credited to the account of the call recipient upon completion of the provision of goods and/or services (734). Preferably, the per-call bid amount charged is automatically credited to the account of the call recipient. The promoter (736) makes a profit on the difference between the fee collected from the customer and the amount paid to the call recipient.

Even though the above-provided description relating to FIG. 7 is directed to a customer initiated contact in the form of a telephone call, such as a cell phone or POTS “land line” call, the present invention is not limited as such. Other forms of routing are also compatible with the present invention. Live voice conversations can be conducted via the internet, VoIP links, satellite enabled uplinks (e.g. OnStar™), automated dialers (including pre-programmed telephone or contact numbers), and any other system that does not require the potential customer to dial an actual telephone number. Dynamic routing of non-voice based customer contacts, such as electronic messages, including text messages, SMS messages, e-mail messages, instant messages, and the like, are also compatible with the present invention. For example, an e-mail originated customer contact is routable to the relevant call recipient e-mail address, telephonic device, SMS device, or the like. Similarly, an SMS or text message initiated customer request is routable to the corresponding call recipient SMS device, telephonic device, or the like. The call recipient can respond by electronic message or by otherwise contacting the potential customer. Similar steps illustrated in FIG. 7 are applicable to each type of communication contact initiated by the customer.

During system design, the promoter can create a scoring system that allows customers to rate call recipients. Rating criteria may include call recipient satisfaction or service valuation. The rating system may also allow the promoter and/or host to rank call recipient by “stars” or “highest rated” call recipient. Call recipients with low scores may have to pay higher minimum bids or even terminate system participation so that the system can maintain customer confidence. Such quality control gives customers ample feedback regarding call recipient performance. The customer may electronically rate the call recipient at the end of a call or during a follow up call from the promoter and/or host. The promoter and/or host may also obtain call recipient satisfaction rating and reputation information from parallel websites. Ratings generated by customers on other websites may include reviews, expert feedback, etc. An example of such a third party website might include www.angieslist.com. Customers otherwise dissatisfied with an experience with a call recipient may go back to a call recipient call list to select a new call recipient. Alternatively, the system may automatically route the customer to the next call recipient on the call recipient call list. This system function is similar to an internet search engine results page such that the customer has the option to choose a first call recipient (or first link on the internet search engine results page), speak with that specific call recipient and, if dissatisfied with the experience, go back to the call recipient list and select a second call recipient (a second link on the internet search engine results page). This feature of the present invention is similar to an internet search engine experience, but over the telephone. Additionally, customers may be recorded during calls so that the system administrator may monitor the quality therein. The above-described measures insure the overall quality of the system and the value of the routed calls.

In another alternative embodiment, the process for dynamically routing telephone customer contacts in real-time is facilitated via an internet browser integrated into a telephone. For example, cell phones are now capable of accessing the internet via any one of a number of internet browsers installed therein. The cell phone enabled internet browsers are often streamlined versions of larger, more comprehensive web browsers used with personal computers. But, any internet enabled telephonic communications device, such as cell phones, VoIP, personal data assistants having telephone and internet connectivity, or computers capable of making or receiving telephone calls are compatible with this embodiment. In accordance with the present invention, a customer accesses a call recipient search engine webpage via the internet enabled browser. Accordingly, the customer searches for a call recipient by entering a set of search criteria. The search criteria includes, but is not limited to, keywords, geography, type of goods or services, etc. In this embodiment, the search engine webpage displays a contact list of call recipients matching the search criteria. The contact list is orderable according to any of the methods or algorithms disclosed herein, such as bid amount, geographic location, or relevance of the keywords. For example, the highest bidding call recipient is first on the contact list and is followed by lower bidding call recipients in hierarchical order. Alternatively, the search engine webpage displays the three highest bidding call recipients followed by a series of non-bidding call recipients. The customer selects a call recipient directly from the search engine webpage via the internet enabled browser. Thereafter, the telephone immediately dials the telephone number of the selected call recipient in order to establish the real-time customer contact with the call recipient. In an alternative embodiment, the internet enabled web browser automatically connects the customer to a call recipient. For example, the customer searches for a call recipient by entering a set of search criteria into a call recipient search engine via the internet enabled web browser. Thereafter, the routing system of the present invention immediately routes the customer contact to a call recipient without first displaying the contact list or any other aspect of the search results. The real-time communication link between the customer and the call recipient is thereafter established.

Additionally, Promoters may need to pay the host a flat fee to operate the system of the present invention. The terms of the fee are governed by the contractual obligation with the host. The contract may require payment for each new registered call recipient. Alternatively, payment may consist of a portion of each per-contact charge. Payments are payable on a periodic basis by sending the call recipient an account statement. Alternatively, the promoter account can be automatically increased for each charged contractor. The promoter may directly debit the call recipient accounts or bill the call recipients on a periodic basis. Accordingly, the promoter pays the host according to any of the above-described methods.

Call recipients are able to advertise services on an as-needed basis. Paying for advertising occurs only when call recipients need work or are in a position to receive more contacts. Customers are directly routed to call recipients able to immediately respond to the needs of the customer.

In another alternative embodiment, the present invention may facilitate the competitive bidding system through the internet. Customers or call recipients may access a specific service or advertise a specific service through an internet search engine. The online system facilitates competitive bidding concerning how much a call recipient is willing to pay to receive a customer contact.

The present invention also enables promoters to build viable businesses based on dynamic call routing to various businesses and/or call recipients. Promoters may modify the routing system to fit specific business requirements.

Although several embodiments of the present invention have been described in detail for purposes of illustration, various modifications of each may be made without departing from the spirit and scope of the invention. Accordingly, the invention is not to be limited, except by the appended claims.

What is claimed is:

1. A process for dynamically routing a telephone customer contact in real-time, comprising the steps of:
establishing accounts for call recipients in an electronic database;
creating a contact list of call recipients from the accounts in the electronic database;
ranking the call recipients on the contact list;
receiving a contact from a customer; and
routing the customer to a call recipient on the contact list.

2. The process of claim 1, including the step of permitting the call recipients to bid against one another for priority on the contact list.

3. The process of claim 2, wherein the call recipients may place multiple bids.

4. The process of claim 2, including the step of only listing call recipients on the contact list that bid below a maximum bid.

5. The process of claim 2, wherein the contact list at least partially comprises non-bidding call recipients.

6. The process of claim 5, wherein the bidding call recipients are a higher priority on the contact list relative to the non-bidding call recipients.

7. The process of claim 1, including the step of notifying the call recipients when the call recipients change rank on the contact list.

8. The process of claim 1, wherein the customer is routed to a call recipient selected by the customer.

9. The process of claim 8, including the step of rerouting the customer to a new call recipient selected by the customer from the contact list.

10. The process of claim 1, wherein the ranking step includes the step of organizing the contact list from a lowest bidding call recipient to a highest bidding call recipient, wherein the customer is routed to the lowest bidding call recipient.

11. The process of claim 10, including the step of rerouting the customer contact to a next lowest bidding call recipient on the contact list if the lowest bidding call recipient does not respond to or rejects the customer contact.

12. The process of claim 1, wherein the ranking step includes the step of organizing the contact list from a highest bidding call recipient to a lowest bidding call recipient, wherein the customer is routed to the highest bidding call recipient.

13. The process of claim 12, including the step of rerouting the customer contact to a next highest bidding call recipient on the contact list if the highest bidding call recipient does not respond to or rejects the customer contact.

14. The process of claim 1, wherein the ranking step includes the step of organizing the contact list according to the proximity of the call recipient to the customer, wherein the customer is routed to the call recipient located nearest to the customer.

15. The process of claim 14, including the step of rerouting the customer contact to a next nearest call recipient on the contact list if the nearest call recipient does not respond to or rejects the customer contact.

16. The process of claim 1, wherein the ranking step includes the step of organizing the contact list according to a geographic location of the customer.

17. The process of claim 16, including the step of determining the geographic location of the customer by customer-provided geographic information, customer telephone caller identification, GPS-assisted location, triangulation, operator-assisted location, geolocation, satellite, or cell phone company-assisted location.

18. The process of claim 1, wherein the ranking step includes the step of organizing the contact list according to a rating of each call recipient on the contact list, wherein the customer is routed to a highest rating call recipient.

19. The process of claim 18, including the step of rerouting the customer contact to a next highest rating call recipient if the highest rating call recipient does not respond to or rejects the customer contact.

20. The process of claim 1, wherein the ranking step includes the step of organizing the contact list according an algorithm based on a call recipient bid, the proximity of the call recipient to the customer, a geographic location of the customer, or a call recipient rating, wherein the customer is routed to a first call recipient according to the algorithm.

21. The process of claim 20, including the step of rerouting the customer contact to a second call recipient according to the algorithm if the first call recipient does not respond to or rejects the customer contact.

22. The process of claim 1, wherein the customer contact is received via a real-time communications link comprising a telephonic link, a voice over internet protocol link, a satellite-enabled voice link, or an audio-visual link.

23. The process of claim 1, wherein the customer contact comprises a live conversation between the consumer and the call recipient via a real-time communications link or a customer initiated electronic message.

24. The process of claim 1, including the step of billing the customer a flat fee for the call recipient contact or for goods and/or services received from the call recipient.

25. The process of claim 24, including the step of crediting the call recipient account in an amount bid by that call recipient for receiving the customer contact.

26. The process of claim 25, wherein the crediting step includes the step of paying the call recipient on a periodic basis.

27. The process of claim 1, wherein the creating step includes the step of combining multiple contact lists to form the provided contact list.

28. The process of claim 1, including the step of conveying an advertisement to the customer before providing the contact list or before routing the customer to a call recipient on the contact list.

29. The process of claim 28, wherein a plurality of advertisers bid against one another for priority to convey the advertisement.

30. The process of claim 28, including the step of charging an advertiser a bid amount or a flat fee per advertisement conveyed.

31. The process of claim 28, wherein the advertisement correlates to the customer contact, an advertiser bid, or an advertiser rating.

32. The process of claim 1, wherein the receiving step includes the step of selecting goods and/or services to generate the customer contact.

33. The process of claim 1, further including the step of advertising the call recipient contact system to customers and potential call recipients.

34. The process of claim 1, including the step of charging the call recipient a bid amount per customer connection or call recipient listing, a flat fee per call recipient listing, or a percentage of the bid amount per customer connection.

35. A process for dynamically routing a telephone customer contact in real-time, comprising the steps of:
establishing accounts for call recipients in an electronic database;
creating a contact list of call recipients from the accounts in the electronic database, wherein the contact list at least partially comprises non-bidding call recipients;
permitting the call recipients to bid against one another for priority on the contact list;
ranking the call recipients on the contact list according to the proximity of the call recipient to a customer;
receiving a contact from the customer;
routing the customer to a call recipient on the contact list located nearest to the customer; and
rerouting the customer contact to a next nearest call recipient on the contact list if the nearest call recipient does not respond to or rejects the customer contact.

36. The process of claim 35, further including the step of listing only call recipients on the contact list that bid below a maximum bid, wherein the call recipients may place multiple bids.

37. The process of claim 35, wherein the bidding call recipients are a higher priority on the contact list relative to the non-bidding call recipients.

38. The process of claim 35, including the step of notifying the call recipients when the call recipients change rank on the contact list.

39. The process of claim 35, further including the steps of:
providing the contact list to the customer;
routing the customer to a call recipient selected by the customer; and
rerouting the customer to a new call recipient selected by the customer from the contact list.

40. The process of claim 35, further including the steps of:
organizing the contact list from a lowest bidding call recipient to a highest bidding call recipient, wherein the customer is routed to the lowest bidding call recipient; and
rerouting the customer contact to a next lowest bidding call recipient on the contact list if the lowest bidding call recipient does not respond to or rejects the customer contact.

41. The process of claim 35, further including the steps of:
organizing the contact list from a highest bidding call recipient to a lowest bidding call recipient, wherein the customer is routed to the highest bidding call recipient; and
rerouting the customer contact to a next highest bidding call recipient on the contact list if the highest bidding call recipient does not respond to or rejects the customer contact.

42. The process of claim 35, further including the steps of:
organizing the contact list according to a geographic location of the customer; and
determining the geographic location of the customer by customer-provided geographic information, customer telephone caller identification, GPS-assisted location, triangulation, operator-assisted location, geolocation, satellite, or cell phone company-assisted location.

43. A process for dynamically routing a telephone customer contact in real-time, comprising the steps of:
establishing accounts for call recipients in an electronic database;
creating a contact list of call recipients from the accounts in the electronic database, wherein the contact list at least partially comprises non-bidding call recipients;
permitting the call recipients to bid against one another for priority on the contact list, wherein the bidding call recipients are a higher priority on the contact list relative to the non-bidding call recipients;
listing only call recipients on the contact list that bid below a maximum bid, wherein the call recipients may place multiple bids;
ranking the call recipients on the contact list according to the proximity of the call recipient to a customer;
receiving a contact from the customer;
routing the customer to a call recipient on the contact list located nearest to the customer; and
rerouting the customer contact to a next nearest call recipient on the contact list if the nearest call recipient does not respond to or rejects the customer contact.

44. The process of claim 43, further including the steps of:
notifying the call recipients when the call recipients change rank on the contact list;
providing the contact list to the customer;
routing the customer to a call recipient selected by the customer; and
rerouting the customer to a new call recipient selected by the customer from the contact list.

45. The process of claim 43, further including the steps of:
organizing the contact list from a lowest bidding call recipient to a highest bidding call recipient, wherein the customer is routed to the lowest bidding call recipient; and
rerouting the customer contact to a next lowest bidding call recipient on the contact list if the lowest bidding call recipient does not respond to or rejects the customer contact.

46. The process of claim 43, further including the steps of:
organizing the contact list from a highest bidding call recipient to a lowest bidding call recipient, wherein the customer is routed to the highest bidding call recipient; and
rerouting the customer contact to a next highest bidding call recipient on the contact list if the highest bidding call recipient does not respond to or rejects the customer contact.

47. The process of claim 43, further including the steps of:
organizing the contact list according to a geographic location of the customer; and
determining the geographic location of the customer by customer-provided geographic information, customer telephone caller identification, GPS-assisted location, triangulation, operator-assisted location, geolocation, satellite, or cell phone company-assisted location.
